(19) United States
(12) Patent Application Publication
(10) Pub. No.: US 2005/0044437 A1
(43) Pub. Date: Feb. 24, 2005

(54) Power conservation in the absence of AC power

(76) Inventors: Robert A. Dunstan, Forest Grove, OR (US); Donald R. Alexander, Beaverton, OR (US)

Correspondence Address: SCHWABE, WILLIAMSON & WYATT, P.C.;PACWEST CENTER, SUITES 1600-1900, 1211 SW FIFTH AVENUE, PORTLAND, OR, 97204, US

(21) Appl. No.: 10/644,684

(22) Filed: Aug. 19, 2003

(51) Int. Cl. G06F 1/26

(52) U.S. Cl. 713/322

(57) ABSTRACT

A system is provided with the ability to throttle one or more hardware elements of the system to reduce power consumption of the one or more hardware elements, in response to an AC absence condition. In one embodiment, the system is further provided with the ability to delay suspending the system to memory in response to the AC absence condition. Further, the system is provided with the ability to return the one or more hardware elements to their normal power consumption, and cancel the delayed suspending of the system to memory, if AC returns while the system is still active.

### BACKGROUND

Advances in integrated circuits and microprocessor technologies have made possible the availability of computing devices, such as personal computers, with computing power that was once reserved for “main frames”. As a result, increasingly computing devices, such as personal computers, are being used for a wide array of computations, and often, “important” computations.

However, computing devices, such as personal computers, are still being provided without integral backup power support. Further, unlike their server brethrens, typically, supplemental external backup power supports are seldom employed. Thus, whenever the power supply fails, these computing devices go into an un-powered state, and the system states are lost.

For those computing devices endowed with power management implemented in accordance with the Advanced Configuration and Power Interface (ACPI) (jointly developed by Hewlett Packard, Intel, et al), the computing devices are said to be in the “un-powered” G3 state.

Moreover, when power is restored, and a user presses the power button of the computing device, the user typically gets a number of messages from the operating system (OS) of the computing device. Unfortunately, many of these messages are understood by sophisticated users only. Examples of these messages include asking the user whether the user desires to boot the computing device into a safe mode, have the disk drive scanned, and so forth.

If acceptance of computing devices, such as personal computers, is to continue to expand, and the computing devices are to be used by more and more users for an increasing variety of applications, such as “entertainment” applications, it is necessary for their usability, availability, and/or reliability to continue to improve. Further, it is necessary for the usability, availability, and/or reliability to be improved cost effectively.

### BRIEF DESCRIPTION OF THE DRAWINGS

Embodiments of the present invention will be described by way of the accompanying drawings in which like references denote similar elements, and in which:

FIG. 1 illustrates an overview of a system incorporated with the teachings of one embodiment of the present invention, including a processor equipped to operate in a selected one of at least two power consumption levels, an operating system equipped to exploit the processor's power conservation ability;

FIG. 2a illustrates the operational states of the system of FIG. 1, in accordance with one embodiment;

FIG. 2b illustrates one embodiment of the power supply of FIG. 1 in further details, including a monitor for monitoring presence/absence of AC and a DC power source;

FIG. 2c illustrates an example article having programming instructions implementing all or the relevant portions of the OS of FIG. 1, in accordance with one embodiment;

FIG. 3 illustrates one embodiment of the relevant operation flow of the system to suspend the system to memory in responding to an AC failure condition, while operating in an active state, including throttling the processor to operate at a reduced power consumption level and delaying the suspension; and

FIG. 4 illustrates one embodiment of the relevant operation flow of the system in responding to an AC re-presence condition, including un-throttling the processor to return to operate at a normal higher power consumption level if the system is in an active state, and canceling a count down towards suspending the system to memory.

### DETAILED DESCRIPTION OF EMBODIMENTS OF THE INVENTION

Embodiments of the present invention include but are not limited to method for conserving power when AC fails, operating system equipped to facilitate practice of the method, power supply equipped to signal AC failure, and components, circuit boards or devices endowed with the chipset and/or the power supply.

In the following description, various aspects of embodiments of the present invention will be described. However, it will be apparent to those skilled in the art that other embodiments may be practiced with only some or all of the described aspects. For purposes of explanation, specific numbers, materials and configurations are set forth in order to provide a thorough understanding of the embodiments. However, it will be apparent to one skilled in the art that other embodiments may be practiced without the specific details. In other instances, well-known features are omitted or simplified in order not to obscure the description.

Various operations will be described as multiple discrete operations in turn, in a manner that is most helpful in understanding the embodiments, however, the order of description should not be construed as to imply that these operations are necessarily order dependent. In particular, these operations need not be performed in the order of presentation.

The phrase “in one embodiment” is used repeatedly. The phrase generally does not refer to the same embodiment, however, it may. The terms “comprising”, “having” and “including” are synonymous, unless the context dictates otherwise.

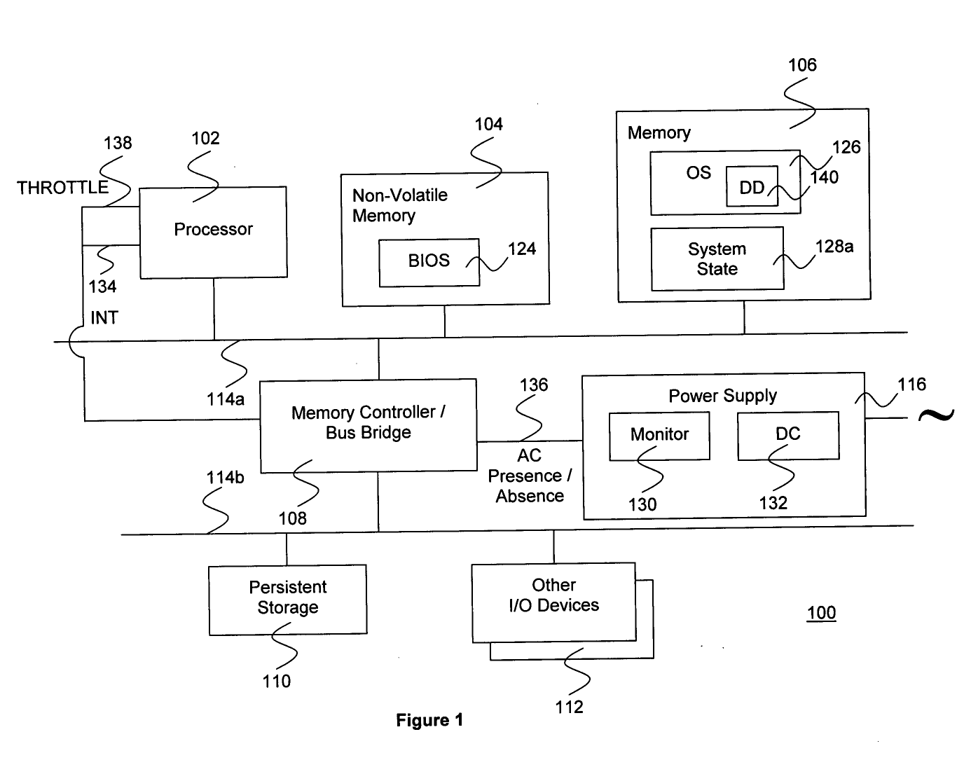

Referring now to FIG. 1 wherein an overview of a system incorporated with the teachings of one embodiment of the present invention is illustrated. For the embodiment, system 100 includes processor 102, non-volatile memory 104, memory 106, controller/bus bridge 108, persistent storage 110, other I/O devices 112, buses 114a-114b, and power supply 116, coupled to each other as shown. Controller/bus bridge 108 will also be referred to as memory and I/O controller/bus bridge, or MCH/ICH/BB.

Processor 102 is equipped to operate in one of at least two power consumption levels, a normal power consumption level, and a reduced power consumption level. Further, processor 102 includes throttle terminal (e.g. pin) 138 to facilitate being instructed as to which one of the at least two power consumption levels it should operate in.

In one implementation, processor 102 is equipped to effectuate the at least two levels of power consumption by being able to operate in one of at least two clock frequencies, a normal clock frequency consuming power at the normal power consumption level, and a reduced clock frequency consuming power at the reduced consumption level.

In another implementation, processor 102 is equipped to effectuate the at least two levels of power consumption by being able to operate in one of at least two voltage levels, a normal voltage level consuming power at the normal power consumption level, and a reduced voltage level consuming power at the reduced consumption level.

In yet another implementation, processor 102 is equipped to effectuate the at least two levels of power consumption by being able to operate in one of at least two execution modes. In a first execution mode, the processor clock is not interrupted. Resultantly, up to n instructions may be executed per time period t, and consuming power at the higher power consumption level. In the second execution mode, the processor clock is periodically interrupted, resulting in the number of instructions that can be executed per time period t being less than n, and consuming power at the reduced power consumption level.

In yet other embodiments, a combination of one or more of the above and other techniques may be practiced to effectuate the differential levels of power consumption.

Non-volatile memory 104 includes in particular basic input/output system (BIOS) 124. Memory 106 includes a working copy of operating system (OS) 126 incorporated with the teachings of one embodiment of the present invention and system state data 128a. The term “system state” as used herein includes OS and application states and data.

MCH/ICH/BB 108 is equipped to interrupt processor 102, when system 100 is in an active state and an AC failed or absent condition arises. More specifically, for the embodiment, the interrupt is issued by the ICH portion of MCH/ICH/BB 108. MCH/ICH/BB 108 is further equipped to facilitate OS 126 to cause system 100 to go into the “suspended to memory” state. Further, MCH/ICH/BB 108 is equipped to shut off delivery of “normal” power (leaving only standby power) to cause system 100 to go into a “suspended to memory” state. MCH/ICH/BB 108 is also equipped to process device wake events, including a notification of AC re-presence while system 100 is in a suspended to memory state. In particular, MCH/ICH/BB 108 is equipped to allow resumption of delivery of “normal” power, initiate waking of system 100, and facilitate BIOS to initiate a resume process. Similarly, for the embodiment, processing of device wake events is performed at the ICH portion MCH/ICH/BB 108. [AC=Alternating Current.]

Power supply 116 includes integral backup DC power source 132, to source power for system 100 while system 100 is in an AC failed or absence condition, and a monitor 130 equipped to signal 136 presence or absence of AC power at power supply 116. An example of integral backup DC power source of power 132 is a battery. For the purpose of present application, the terms “AC failed” or “AC absence” should be considered synonymous, unless the context clearly indicates to the contrary. Hereinafter, integral backup DC power source 132 may also be simply referred to as either backup power source or DC power source. Further, in alternate embodiments backup power source may be a non-DC power source. [DC=Direct Current.]

As will be described in more detail below, processor 102 is caused to operate at the reduced power consumption level, whenever system 100 is powered by integral DC power source 132. Resultantly, by virtue of the reduced load, system 100 may be provided with backup power, in particular, integral back up power, employing a smaller and less costly unit. In other words, integral backup power, and therefore in turn, improved availability, reliability and/or usability, may be provided in a more cost effective manner.

Still referring to FIG. 1, except for the teachings of an embodiment of the present invention incorporated, processor 102, non-volatile memory 104, memory 106, MCH/ICH/BB 108, persistent storage 110, I/O devices 112, and buses 114a-114b all represent corresponding broad ranges of these elements. In particular, an example of an I/O device is a networking interface. In various embodiments, some of these elements, such as MCH/ICH/BB 108 may be packaged in the form of a chipset. Similarly, except for the teachings of an embodiment of the present invention incorporated, BIOS 124 and OS 126 also represent corresponding broad ranges of the elements.

Various embodiments of the teachings incorporated in power supply 116, operating system 126, the operational states and various operational flows of system 100 will be described in turn below.

In various embodiments, system 100 may be a desktop computer, a set-top box, an entertainment control console, a video recorder, a video player, or other processor based system of the like.

Further, alternate embodiments may be practiced without some of the enumerated elements or with other elements. In particular, alternate embodiments may be practiced without DC power source 132 being an integral part of system 100. That is, for these embodiments, DC power is provided from a source external to system 100.

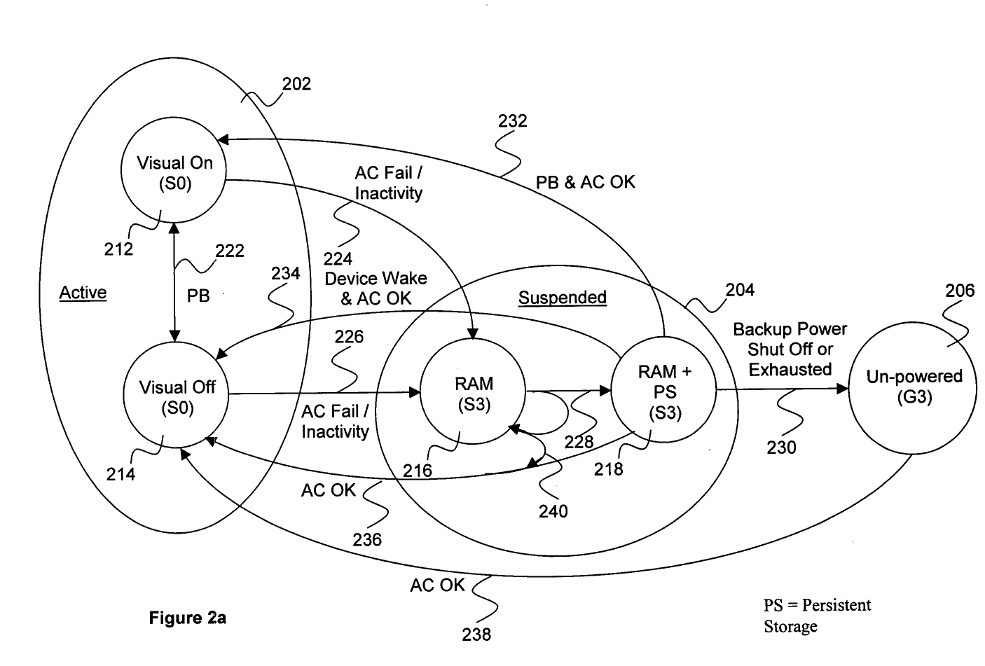

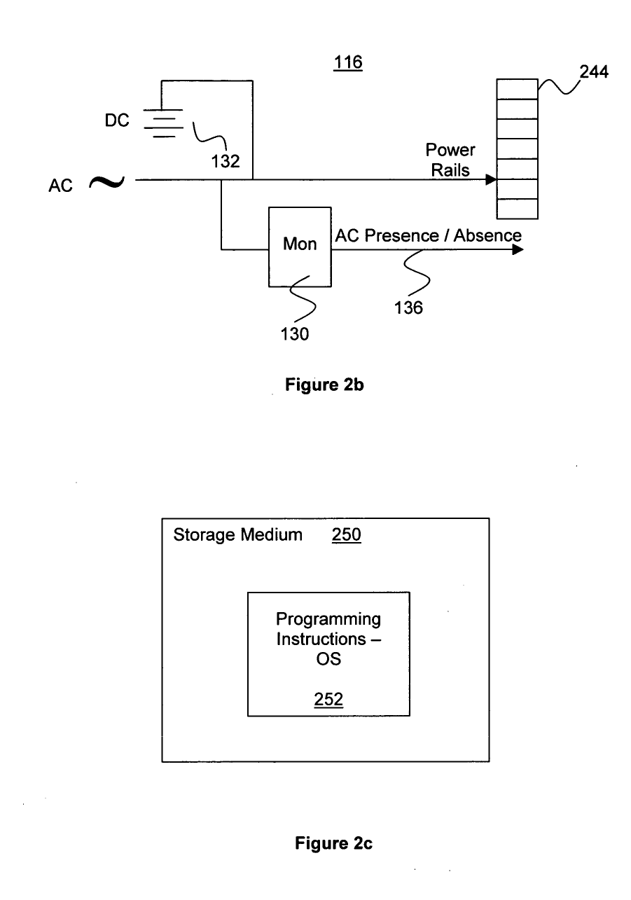

FIG. 2a illustrates one embodiment of the operational states of system 100. For ease of understanding, the operational states will be described assuming system 100 also includes implementation of ACPI, and mapped to the ACPI states. For the embodiment, the operational states of system 100 include three major operational states, active state (ACPI S0 or simply, S0) 202, suspended state (ACPI S3 or simply, S3) 204 and un-powered state (ACPI G3 or simply G3) 206. However, alternate embodiments may be practiced without mapping to ACPI states or implementation of ACPI. For further information on ACPI including ACPI states, see The ACPI Specification, Revision 2.0b.

Within active state (S0) 202, system 100 may be in “visual on” state 212, or “visual off” state 214. While system 100 is in “visual on” state 212, user perceptible indications of system activity may be selectively activated as appropriate, including but are not limited to display devices, light emitting diodes (LEDs), speakers, and so forth. On the other end, while system 100 is in “visual off” state 214, all visual and aural elements of system 100 are “off”, giving a user the impression that system 100 has been “turned off”. As illustrated, system 100 may transition between “visual on” state 212 and “visual off” state 214 based at least in part on power button (PB) events 222.

Having visual “on” and “off” states 212 and 214 within active state (SO) 202 is a non-essential aspect of the disclosed embodiments of the present invention. The feature is the subject matter of co-pending U.S. patent application No. <to be inserted>, entitled <insert title>, and filed on mm/dd/yy. For further details, see the co-pending application.

Still referring to FIG. 2a, for the embodiment, within suspended state (S3) 204, system 100 may be in “suspended to memory” state 216 or “suspended to memory with a persistent copy of the system state saved” state 218. System 100 may enter into “suspended to memory” state 216 from either “visual on” state 202 or “visual off” state 204, due to e.g. “inactivity”, user instruction, or an “AC failure” condition, 224 and 226. As will be described in more detail below, by virtue of the teachings of embodiments of the present invention incorporated to reduce the power consumption of at least one hardware element, such as processor 102, entry into “suspended to memory” state 216 for embodiments of system 100 may be advantageously delayed. Further, entry into “suspended to memory” state 216 for embodiments of system 100 may be advantageously avoided, if AC is returned before the suspend process is initiated. System 100 is considered to be in the “AC failure” condition, whenever AC is not present at power supply 116.

Additionally, for the embodiment, as part of the entry into the “suspended to memory” state 216, a persistent copy of the then system state is saved, resulting in system 100 automatically transitions from “suspended to memory” state 216 to “suspended to memory with a persistent copy of the system state saved” state 218.

Automatic saving of a persistent copy of the then system state is also not an essential aspect of the disclosed embodiments of the present invention. The feature is the subject matter of co-pending U.S. patent application No. <to be inserted>, entitled “Operational State Preservation in the Absence of AC Power”, and filed contemporaneously. For further details, see the co-pending application.

From “suspended to memory with a persistent copy of the system state saved” state 218, system 100 may enter un-powered state (G3) 206 if the integral DC power source is shut off or exhausted 230. Shutting the DC power source off to prevent it from being exhausted is also not an essential aspect of the disclosed embodiments of the present invention. The feature is the subject matter of co-pending U.S. patent application No. <to be inserted>, entitled “Automatic Shut Off of DC Power Source in the Extended Absence of AC Power”, and filed contemporaneously. For further details, see the co-pending application.

From “suspended to memory with a persistent copy of system state saved” state 218, system 100 may transition back to either “visual on” state 212 or “visual off” state 214 in response to AC re-present, or a power botton/device wake event 232/234 if AC is present (state 218 entered due to inactivity). In various embodiments, the after transitions are permitted only if AC is present at power supply 116 (state 218 entered due to inactivity), else the power button or device wake events are suppressed or ignored.

Suppressing or ignoring power button and device wake events when AC is absent, is also not an essential aspect of the disclosed embodiments of the present invention. The feature is the subject matter of co-pending U.S. patent application No. <to be inserted>, entitled “Power button and Device Wake Events Processing Methods in the Absence of AC Power”, and filed contemporaneously.

Further, system 100 returns to “visual off” state 214 if AC becomes present again while system 100 is in “un-powered” state (G3) 206.

Referring now to FIG. 2b, wherein one embodiment of power supply 116 is illustrated. As shown, for the embodiment, power supply 116 includes integral backup DC power source 132 and monitor 130 as described earlier. Additionally, power supply 116 includes multiple power outputs (also referred to as power rail) 244. The elements are coupled to each other as shown.

Accordingly, power outputs 244 may continue to supply power to elements of system 100, drawing on integral DC power source 132, in the absence of AC at power supply 116. Further, monitor 130 is able to output a signal denoting whether AC is present or absent at power supply 116 at any point in time.

In various embodiments, DC power source 132 may be a battery. Monitor 130 may be implemented employing a diode and RC coupled to a comparator to provide signal 136. Further, a logical “1” of signal 136 denotes AC present at power supply 116, whereas a logical “0” of signal 136 denotes AC absent at power supply 116.

In various embodiments, power outputs 244 may include normal and standby power outputs. Normal power outputs may include +12 v, +5 v, +3 v, and −12 v, whereas standby power output may include +5 v. Further, the normal power outputs may be turned off.

FIG. 2c illustrates an example article having programming instructions implementing all or the relevant portions of OS 126 of FIG. 1, in accordance with one embodiment. As illustrated, article 250 includes a storage medium 252 and programming instructions 252 implementing all or the relevant portions of OS 126 of FIG. 1. As alluded to earlier and to be described in more detail below, OS 126 includes teachings of one embodiment of the present invention to facilitate delaying and possibly avoiding suspension of system 100 to memory.

For the embodiment, article 250 may be a diskette. In alternate embodiments, article 250 may be a compact disk (CD), a digital versatile disk (DVD), a tape, a compact Flash, or other removable storage device of the like, as well as a mass storage device, such as a hard disk drive, accessible for downloading all or the relevant portions of OS 126 via e.g. a networking connection.

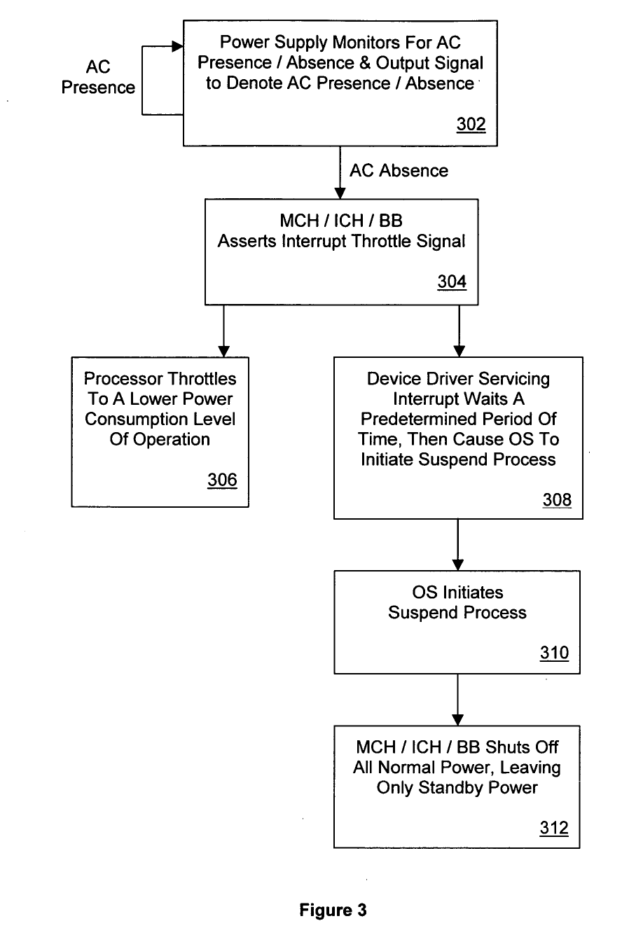

FIG. 3 illustrates one embodiment of the relevant operation flow of system 100 to suspend system 100 to memory in responding to an AC failure condition, while operating in active state 202.

As illustrated, while operating in active state 202, power supply 116 monitors for AC presence or absence, and outputs a signal to denote AC presence or absence accordingly, block 302. In alternate embodiments, the monitoring and signaling of AC presence or absence at power supply 116 may be performed by another element other than power supply 116. Regardless, the monitoring and signaling continues as long as AC is present at power supply 116.

However, when AC fails or absents from power supply 116, and monitor 130 outputs a signal so denoting, for the embodiment, MCH/ICH/BB 108 asserts interrupt 134, which is also applied as throttle signal 138, notifying processor 102 to throttle back, and operate in the reduced power consumption level, block 304.

In response, processor 102 throttles back to operate in the reduced power consumption level as instructed, block 306. As described earlier, processor 102 may throttle back by switching to operate in a reduced voltage and/or clock frequency, and/or interrupting the processor clock periodically.

Concurrently, for the embodiment, an appropriate portion of OS 126 (device driver and/or interrupt handler) is given control to process interrupt 134. However, OS 126 advantageously does not respond to interrupt 134 immediately. Instead, OS 126 allows system 100 to continue to operate (with processor 102 operating in a reduced power consumption level) for at least a period of time, block 308, before responding to interrupt 134, and initiates a suspend process to cause system 100 to transition from a current active state to “suspended to memory” state 216, block 310.

In various embodiments, the suspend process involves OS 126 writing to a special register of MCH/ICH/BB 108 to instruct MCH/ICH/BB 108 to shut off delivery of normal power to elements of system 100, leaving only delivery of standby power, e.g. to memory 106, block 312.

In various embodiments, system 100 is further equipped, and initialized to generate an interrupt and transfer control to BIOS 124 to allow BIOS 124 to intervene in the suspend process. For the embodiment, BIOS 124 intervenes to save a persistent copy of the then system state in persistent storage device 110, such as a hard disk drive, before allowing the suspend process to proceed to completion.

The ability for BIOS 124 to intervene and save a persistent copy of the then system state is also not an essential aspect of the disclosed embodiments of the present invention. It is the subject matter of the above-identified co-pending U.S. patent application No. <to be inserted>.

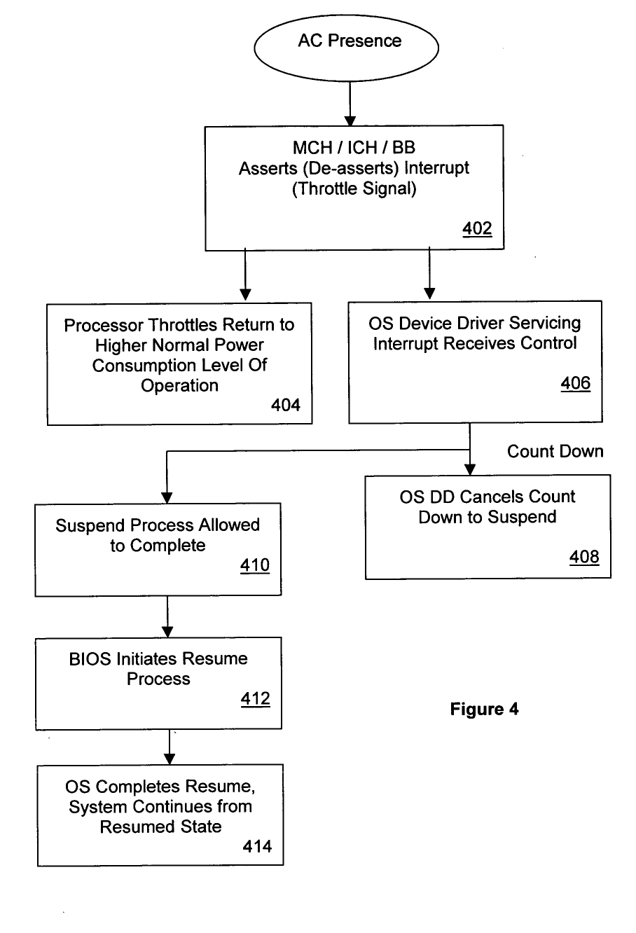

FIG. 4 illustrates one embodiment of the relevant operation flow of system 100 in responding to an AC re-presence condition, while system 100 is in either active state 202 or “suspended to memory” state 216 (or “suspended to memory with a persistent copy of system state saved state 218” (if saving a persistent copy of the system state as an integral part of the suspend process is implemented)).

For the embodiment, re-presence of AC while system 100 is in un-powered state 206 results in a cold start reset process. Further, it results in BIOS 124 determining if a persistent copy of system state is saved, if so, restoring the saved system state into memory, and resuming system operation from the restored system state. Conversion of a cold start reset process to a resume process to allow system 100 to continue operate from a previous saved operating state is also not an essential aspect of the disclosed embodiments of the present invention. It is the subject matter of the above-identified co-pending application Ser. No. <to be inserted>.

Referring now to FIG. 4, as illustrated, if system 100 is in active state 202, MCH/ICH/BB 108 generates interrupt 134, which also results in the de-asserting of throttle signal 138, notifying processor 102 of AC re-presence, block 402.

In response, processor 102 returns to normal operation at the higher power consumption level, block 404. Processor 102 returns to normal operation at the higher power consumption level by resuming operating at the higher voltage and/or clock frequency, and/or ceasing periodic interruption of the processor clock.

Concurrently, execution switches to an appropriate portion of OS 126 (device driver and/or interrupt handler) to respond to interrupt 134, block 406. Recall from earlier discussion, OS 126 may be in a “count down” state towards initiating the suspend process to suspend system 100, or OS is in the middle of the suspend process.

For the former case, OS 126 cancels the “count down”, block 408. As a result, suspension of system 100 is advantageously avoided.

For the later case, the suspend process is allowed to continue to completion, block 410. On completion, BIOS 124 is given control to initiate a resume process to resume system 100 to resume operation, transferring control back to an appropriate portion of OS 126, using e.g. a resume vector created by OS 126 as part of the suspend process, block 412.

At such time, OS 126 completes the resume process, and system 100 continues operation, starting from the suspended operational state in memory 106, block 414. As a result, the length of suspension of system 100 is advantageously minimized.

Thus, it can be seen from the above description, a method to conserve power, in particular, integral DC backup power, in the absence of AC has been described. As described earlier, the feature is particularly useful in enabling a smaller and more cost effective DC power source to be employed to provide integral DC backup power to a computing device.

While the present invention has been described in terms of the foregoing embodiments, those skilled in the art will recognize that the invention is not limited to the embodiments described. Other embodiments may be practiced with modification and alteration within the spirit and scope of the appended claims.

In particular, while the above description has been described with the processor being able to throttle and operate in one of at least two power consumption levels, a reduced power consumption level and a higher consumption level, in alternate elements, other hardware elements, in particular, MCH/ICH/BB or a graphic controller, may also be equipped to so operate in one of at least two power consumption levels.

Further, in lieu of or in addition to the OS being equipped to delay and possibly avoiding suspending the system to memory in the event of AC failure, alternate embodiments may be practiced with the hardware element, e.g. MCH/ICH/BB, responsible for interrupting the processor to switch execution to the appropriate portion of the OS to initiate the suspend process, being equipped to delay, and possibly skipping generation of the interrupt (if AC is returned).

Accordingly, the description is to be regarded as illustrative instead of restrictive.

1. In an apparatus, a method of operation comprising:
powering a hardware element of the apparatus with a power supply of the apparatus;
operating the hardware element at a first power consumption level;
monitoring for absence of AC to the power supply;
generating a signal to indicate AC failure on detection of absence of AC to the power supply; and
in response, throttling the hardware element to operate at a second power consumption level that is a reduced power consumption level than the first power consumption level.

2. The method of claim 1, wherein the monitoring and generating are performed by the power supply.

3. The method of claim 1, wherein
the hardware element operates at a first clock frequency when operating at the first power consumption level; and
the throttling of the hardware element comprises switching the hardware element to operate at a second clock frequency slower than the first clock frequency.

4. The method of claim 1, wherein
the hardware element operates at a first voltage when operating at the first power consumption level; and
the throttling of the hardware element comprises switching the hardware element to operate at a second voltage lower than the first voltage.

5. The method of claim 1, wherein the hardware element comprises a processor and the throttling of the hardware element comprises periodically interrupting a processor clock.

6. The method of claim 1, wherein the hardware element comprises a selected one of a processor and a chipset.

7. The method of claim 1, wherein the method further comprises
waiting for a period of time; and
initiating a process to suspend the apparatus to memory, if AC remains absent to the power supply after waiting for the period of time.

8. The method of claim 7, wherein the method further comprises canceling the wait if AC returns during the waiting period.

9. The method of claim 1, wherein
the hardware element comprises a processor; and
the throttling comprises a chipset in response to the signal, signaling the processor to switch from operating at the first power level of consumption to the second power level of consumption.

10. In an apparatus, a method of operation comprising:
monitoring for re-presence of AC to a power supply of the apparatus after an earlier absence of AC to the power supply;
generating a signal to indicate the presence of AC on detection of re-presence of AC to the power supply; and
throttling a hardware element to switch to operate at a first power consumption level from operating at a second power consumption level, the second power consumption level being a reduced power consumption level than the first power consumption level.

11. The method of claim 9, wherein the monitoring and generating are performed by the power supply.

12. The method of claim 9, wherein
the hardware element operates at a first clock frequency when operating at the first power consumption level, and at a second clock frequency when operating at the second power consumption level, the first clock frequency being faster than the second clock frequency; and
the throttling of the hardware element comprises switching the hardware element from operating at the second clock frequency back to operating at the first clock frequency.

13. The method of claim 9, wherein
the hardware element operates at a first voltage when operating at the first power consumption level, and at a second voltage when operating at the second power consumption level, the first voltage being higher than the second voltage; and
the throttling of the hardware element comprises switching the hardware element from operating at the second voltage to operating at the first voltage.

14. The method of claim 9, wherein the hardware element comprises a processor, and the throttling comprises ceasing interruption of a processor clock.

15. The method of claim 9, wherein
the hardware element comprises a processor; and
the throttling comprises a chipset in response to the signal, signaling the processor to switch to operate at the first power consumption level, from operating at the second power consumption level.

16. A system comprising:
a power supply including a monitor to detect for absence of AC, and generate a first signal to indicate accordingly on so detecting; and
a hardware element coupled to the power supply, and equipped to normally operate in a first power consumption level, and to switch to operate in a second consumption level that is a reduced power consumption level than the first power consumption level, in response to a selected one of the first signal and a second signal generated in view of the first signal.

17. The system of claim 15, wherein
the hardware element operates at a first clock frequency when operating at the first power consumption level; and
the hardware element switches to operate at a second clock frequency that is slower than the first clock frequency, when operating at the second power consumption level.

18. The system of claim 15, wherein
the hardware element operates at a first voltage when operating at the first power consumption level; and
the hardware element switches to operate at a second voltage that is lower than the first voltage, when operating at the second power consumption level.

19. The system of claim 15, wherein
the hardware element comprises a processor;
the processor operates with on an uninterrupted processor clock when operating at the first power consumption level; and
the processor switches to operate interrupting the processor clock periodically, when operating in the second power consumption level.

20. The system of claim 15, wherein the hardware element comprises a selected one of a processor and a chipset.

21. The system of claim 15, wherein
a mechanism coupled to the power supply to facilitate transfer of control to an operating system in response to the first signal; and
the operating system equipped to initiate a suspend process to suspend the system to memory, after waiting a period of time.

22. The system of claim 15, wherein the system further comprises a networking interface.

23. An article of manufacture comprising:
a storage medium; and
a plurality of programming instructions stored on the storage medium, and designed to program an apparatus to enable the apparatus to initiate a suspend process to suspend the apparatus to memory when the apparatus is in an AC failed condition, powered by a backup power, after waiting a period a time.

24. The article of claim 22, wherein the programming instructions are further designed to enable the apparatus to cancel the delayed initiation of the suspend process if AC returns during the waiting period.

25. The article of claim 22, wherein the programming instructions are further designed to enable the apparatus to complete a resume process, continuing operation from a previously suspended system state, if AC returns while the apparatus is in the suspended to memory state.
